(19) United States
(12) Patent Application Publication
(10) Pub. No.: US 2009/0190461 A1
(43) Pub. Date: Jul. 30, 2009

(54) OPTICAL DATA STORAGE SYSTEM FOR RECORDING AND/OR READING AN OPTICAL DATA STORAGE MEDIUM FOR USE IN SUCH SYSTEM

(75) Inventors: Martinus Bernardus Van Der Mark, Eindhoven (NL); Ferry Zijp, Eindhoven (NL); Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Phillips Electronics N.V., Eindhoven (NL)

(21) Appl. No.: 10/599,997

(22) PCT Filed: Apr. 15, 2005
(86) PCT No.: PCT/IB2005/051245

§ 371 Date: Oct. 17, 2006

(30) Foreign Application Priority Data
Apr. 20, 2004 (EP) 0410635.3
Apr. 20, 2004 (EP) 04101635.3

(51) Int. Cl. G11B 7/135; G11B 7/26

(52) U.S. Cl. 369/112.23; 369/283; G9B/7.112; G9B/7.194

(57) ABSTRACT

Multi layer near-field optical recording using a moderate numerical aperture (NA) is superior to the high-NA (NA=2.0) first-surface single-layer technique. The use of very flat and thin spacer layers limits spherical aberration due to difference in layer depth. The thin spacer layers may have a high refractive index because their thickness allow for a relatively high absorption constant. This makes possible in principle an m-layer system, e.g. m=4, with NA=1.6 which may include a flat, protective cover layer. Further a medium for use in such a system is described.

The invention relates to an optical data storage system for recording and/or reading, using a radiation beam having a wavelength λ, focused onto a data storage layer of an optical data storage medium, said system comprising:

the medium, having m data storage layers where m≧2 and a cover layer that is transparent to the focused radiation beam, said cover layer having a thickness h₀ and a refractive index n₀, the data storage layers being separated by m-1 spacer layers having respective thicknesses hⱼ and refractive indices nⱼ, wherein j=1, . . . , m-1,

an optical head, with an objective having a numerical aperture NA, said objective including a solid immersion lens that is adapted for recording/reading at a free working distance of smaller than λ/10 from an outermost surface of said medium and arranged on the cover layer side of said optical data storage medium, and from which solid immersion lens the focused radiation beam is coupled by evanescent wave coupling into the optical storage medium during recording/reading.

The invention further relates to an optical data storage medium suitable for use in such a system.

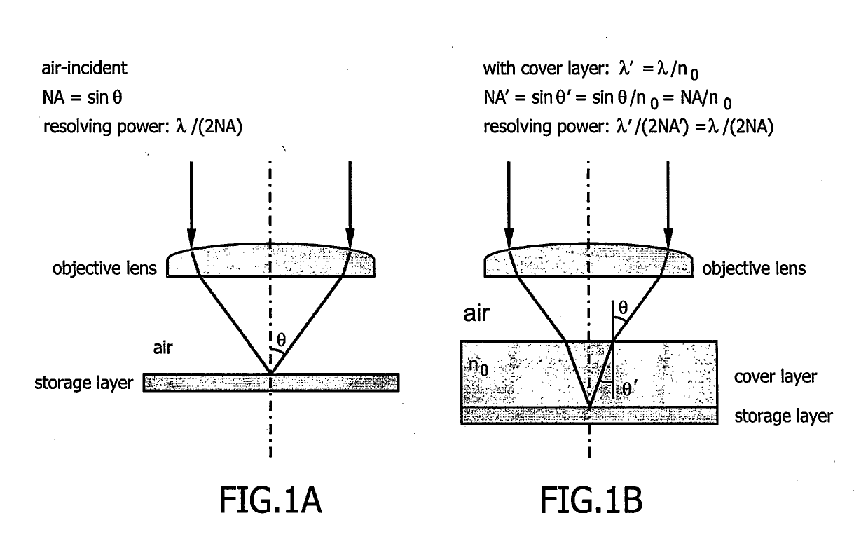

A typical measure for the focussed spot size or optical resolution in optical recording systems is given by w=λ/(2NA), where λ is the wavelength in air and the numerical aperture of the lens is defined as NA=sin θ. In FIG. 1A, an air-incident configuration is drawn in which the data storage layer is at the surface of the data storage medium: so-called first-surface data storage. In FIG. 1B, a cover layer with refractive index n protects the data storage layer from a.o. scratches and dust.

From these figures it is inferred that the optical resolution is unchanged if a cover layer is applied on top of the data storage layer: On the one hand, in the cover layer, the internal opening angle θ′ is smaller and hence the internal numerical aperture NA′ is reduced, but also the wavelength in the medium λ′is shorter by the same factor n₀. It is desirable to have a high optical resolution because the higher the optical resolution, the more data can be stored on the same area of the medium. Straight forward methods of increasing the optical resolution involve widening of the focussed beam opening angle at the cost of lens complexity, narrowing of allowable disk tilt margins, etc. or reduction of the in-air wavelength i.e. changing the colour of the scanning laser.

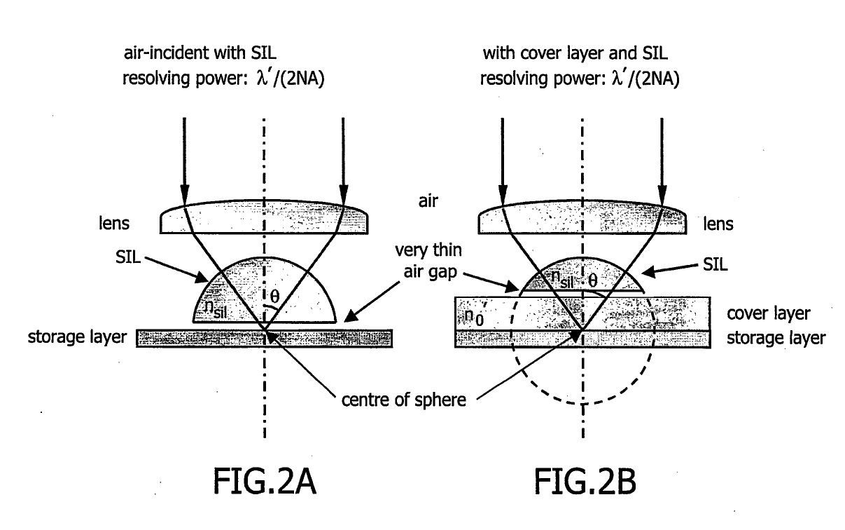

Another proposed method of reducing the focussed spot size in an optical disk system involves the use of a solid immersion lens (SIL). In its simplest form, the SIL is a half sphere centred on the data storage layer, see FIG. 2A, so that the focussed spot is on the interface between SIL and data layer. In combination with a cover layer of the same refractive index, n₀′=n_{SIL}, the SIL is a tangentially cut section of a sphere which is placed on the cover layer with its (virtual) centre again placed on the storage layer, see FIG. 2B. The principle of operation of the SIL is that it reduces the wavelength at the storage layer by a factor n_{SIL}, the refractive index of the SIL, without changing the opening angle θ. The reason is that refraction of light at the SIL is absent since all light enters at right angles to the SIL's surface, compare FIG. 1B and FIG. 2A. The width of the air gap is typically 25-40 nm (but at least less than 100 nm), and is not drawn to scale. The thickness of the cover layer typically is several microns but is also not drawn to scale.

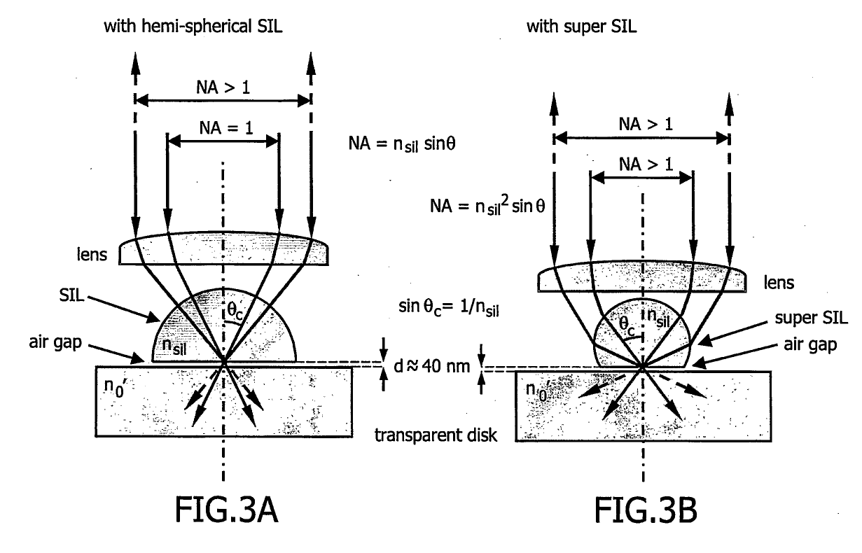

Very important, but not mentioned up until this point, is that there is a very thin air gap between SIL and recording medium. This is to allow for free rotation of the recording disk with respect to the recorder objective (lens plus SIL). This air gap should be much smaller than an optical wavelength, typically it should be smaller than λ/10, such that so-called evanescent coupling of the light in the SIL to the disk and back into the SIL is still possible. The range over which this happens is called the near-field regime. Outside this regime, at larger air gaps, total internal reflection will trap the light inside the SIL and send it back up to the laser. Waves below the critical angle at the SIL to air interface, propagate through the air gap without decay, whereas those above the critical angle become evanescent in the air gap and show exponential decay with the gap width. At the critical angle NA=1. For a large gap width all light above the critical angle reflects from the proximate surface of the SIL by total internal reflection (TIR), see FIGS. 3A and 3B. Here, NA₀ is the numerical aperture of the lens without the SIL being present. In both these lens designs, total internal reflection occurs for NA>1 if the air gap is too wide. If the air gap is thin enough, the evanescent waves make it to the other side and in the transparent disk become propagating again. Note that if the refractive index of the transparent disk is smaller than the numerical aperture, n₀′<NA, that some waves remain evanescent and that effectively NA=n₀′.

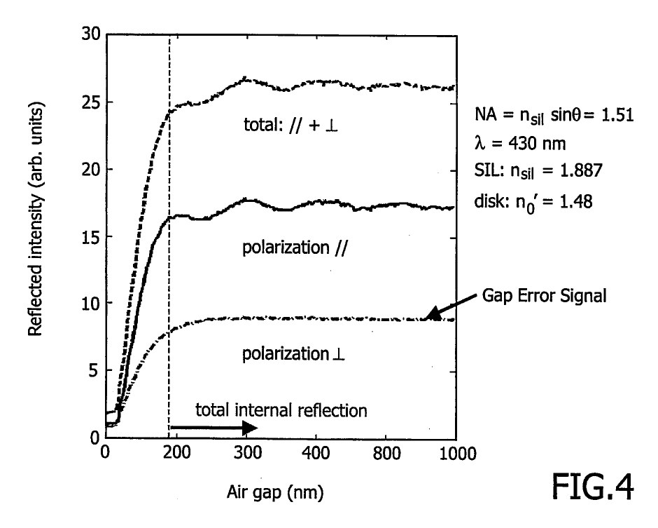

For a wavelength of 405 nm, as is the standard for Blu-Ray optical disk (BD), the maximum air-gap is approximately 40 nm, which is a very small free working distance (FWD) as compared to conventional optical recording. The near-field air gap between data layer and the solid immersion lens (SIL) should be kept constant within 5 nm or less (preferably constant within 2 nm or less) in order to get sufficiently stable evanescent coupling. In hard disk recording, a slider-based solution relying on a passive air bearing is used to maintain such a small air gap. In optical recording, where the recording medium must be removable from the drive, the use of a lubricant is limited and the contamination level of the disk is larger, an active, actuator-based solution to control the air gap will be required. To this end, a gap error signal must be extracted, preferably from the optical data signal already reflected by the optical medium. Such a signal can be found, and a typical gap error signal is given in FIG. 4.

Note that it is common practice in case a near-field SIL is used to define the numerical aperture as NA=n_{SIL} sin θ, which can be larger than 1 (θ is the angle of the marginal ray), although the opening angle θ′<π/2 and NA′=sin θ′<1 inside the cover layer.

Note further that in case a cover layer is used, that the data storage layer is in fact NOT in the near field. There is just an evanescent coupling of waves from the SIL to the cover layer combined with a large numerical aperture inside the cover layer. A more appropriate name for this type of optical storage would be “Constant Evanescent Coupling Optical Storage”, or CECOS. In case of true near-field optical recording, the data can be represented by a surface structure which not only modulates the total reflected intensity but also directly influences the amount of evanescent coupling between the data carrying disk and the objective. In case of CECOS, this evanescent coupling is kept at a constant value, and the data is represented by amplitude or phase structures in the data storage layer, common to the present techniques of optical data storage.

In FIG. 4 we show a measurement (taken from Ref. [1]) of the amounts of reflected light for both the parallel and perpendicular polarisation states with respect to the linearly polarised collimated input beam from a flat and transparent optical surface (“disk”) with a refractive index of 1.48. The perpendicular polarisation state is suitable as an air-gap error signal for the near-field optical recording system. These measurements are in good agreement with theory. The evanescent coupling becomes perceptible below 200 nm, the light vanishes in to the “disk”, and the total reflection drops almost linearly to a minimum at contact. This linear signal may be used as an error signal for a closed loop servo system of the air gap. The oscillations in the horizontal polarisation are caused by the reduction of the number of fringes within NA=1 with decreasing gap thickness.

More details about a typical near-field optical disk system can be found in Ref.
[2].

For optical recorder objectives, either slider-based or actuator-based, having a small working distance, typically less than 50 μm, contamination of the optical surface closest to the storage medium occurs. This is due to re-condensation of water and other materials immediately after it has desorbed from the storage medium because of the high surface temperature, typically 250° C. for Magneto Optical (MO) recording and 650° C. for Phase Change (PC) recording, resulting from the high laser power and temperature required for writing data in, or even reading data from, the data recording layer. The contamination ultimately results in malfunctioning of the optical data storage system due to runaway of, for example, the servo control signals of the focus and tracking system. This problem is a.o. described in the patent applications and patents given in Refs. [3]-[5].

The problem becomes more severe for the following cases: high humidity, high laser power, low optical reflectivity of the storage medium, low thermal conductivity of the storage medium, small working distance and high surface temperature.

A known solution to the problem is to shield the proximal optical surface of the recorder objective from the data layer by a thermally insulating cover layer on the storage medium. An invention based on this insight is for example given in Ref. [4].

Providing the near-field optical storage medium with a cover layer has the additional advantage that dirt and scratches can no longer directly influence the data layer. However, by putting a cover layer onto a near-field optical system, new problems arise, which lead to new measures to be taken. Some of these measures have been described in European patent application simultaneously filed by present applicant with reference number PHNL040460 and PHNL040461, and lead to an important further insight, which is the subject of this invention disclosure: the feasibility of multi-layer near-field recording.

Some advantages of a thin and ultra-flat cover layer are discussed hereafter. With respect to disk tilt, the introduction of a cover layer may cause an aberration known as “coma”. This is a first reason why any cover layer should have a limited thickness, but it is not of our main concern here.

Normally, the near-field air gap between data layer and the solid immersion lens (SIL) should be kept constant within 5 nm or less in order to get sufficiently stable evanescent coupling. In case a cover layer is used, the air gap is located between cover layer and SIL, see FIG. 2B. Again, the air gap should be kept constant to within 5 nm. Clearly, the SIL focal length should have an offset to compensate for the cover layer thickness, such as to guarantee that the data layer is in focus at all times. Note that the refractive index of the cover layer, if it is lower than the refractive index of the SIL, determines the maximum possible numerical aperture of the system.

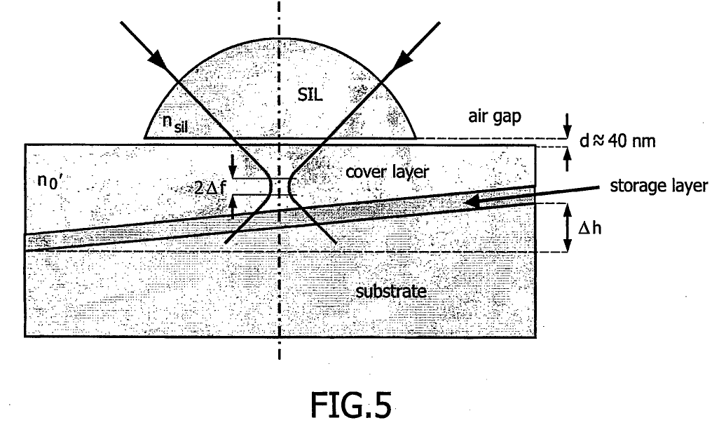

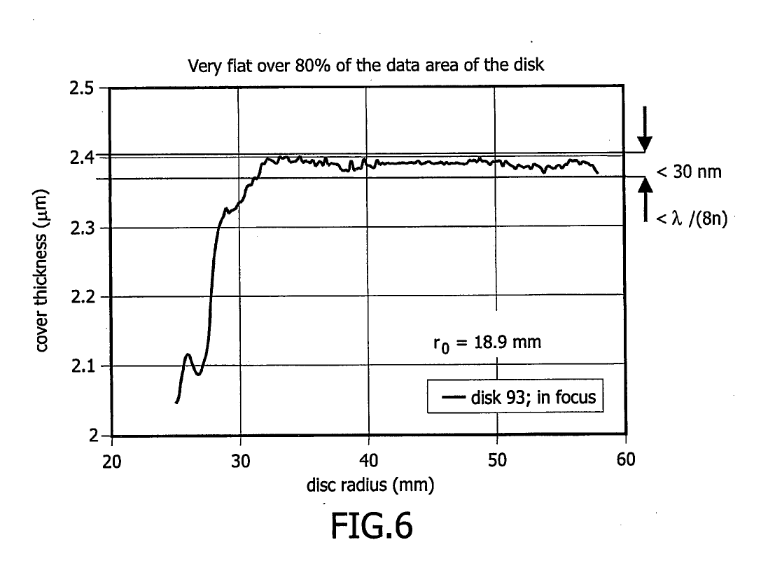

In order to obtain sufficient thermal isolation, the dielectric cover layer thickness should be more than approximately 0.5 μm, but preferably is of the order of 2-10 μm Taken together this means that by controlling the width of the air gap only, the thickness variation of the cover layer Ah should be (much) smaller than the focal depth Δf≈nλ/(2NA²) (the actual focal depth inside a medium is λ/4/[n−(n²−NA²)^{1/2}]≈nλ/(2NA²)) in order to guarantee that the data layer is in focus: Δh<Δf, see FIG. 5. If we take the wavelength λ=405 nm and numerical aperture NA=1.6 we find that Δf≈80 nm. For spin-coated layers of several microns thickness this is of the order of a percent of thickness variation over the entire data area of the disk, which seems a challenging accuracy. However, it has appeared to be possible to make spin-coated layers with the required specifications: Several microns thickness and less than 30 nm thickness variation, see for example FIG. 6 and Refs. [9.] and [10]. The cover layer is very flat over the outer 28 mm which represents already 80% of the data area. This result is remarkable since the fluid was not administered in the centre of the disk (since there is a hole), but at a radius of 18.9 mm. Usually this leads to a very inhomogeneous result, with the cover-layer thickness at the edges much higher than in the middle. In this case, however, a thermal gradient was used to tune the fluid viscosity during the spin process as a function of the disk radius.

Much thinner layers, which have thicknesses of only a fraction of a micron, can be made by, for example sputtering or sol-gel techniques of inorganic compounds. The use of inorganic compounds for thicker layers, in the range of 1-3 microns or more, is impractical from the processing and cost point of view. Also stress build-up in such layers be will likely to cause disk bending.

Overall, it may be concluded that:

A cover layer is needed against contamination and scratches.

A cover layer thicker than 1 μm is needed for thermal insulation in case of a near field optical recording, in particular phase change, system.

The refractive index value of the cover must be greater than the NA value.

Sputtered (inorganic) materials can have a very high refractive index, but sputtered cover layers thicker than 1 μm are not possible on optical disks, mainly due to processing time and disk bending as a result of stress.

It is possible to spin-coat polymer cover layers thicker than 1 μm but polymers possess lower refractive index than some inorganic materials which limits the NA to about 1.6.

In case of multi-layer optical storage, the data layers are sandwiched between spacer layers. These spacer layers have many properties in common with the cover layer. This invention disclosure is mainly about the properties of the spacer layers, and the cover layer issue serves as an introduction to the main insights.

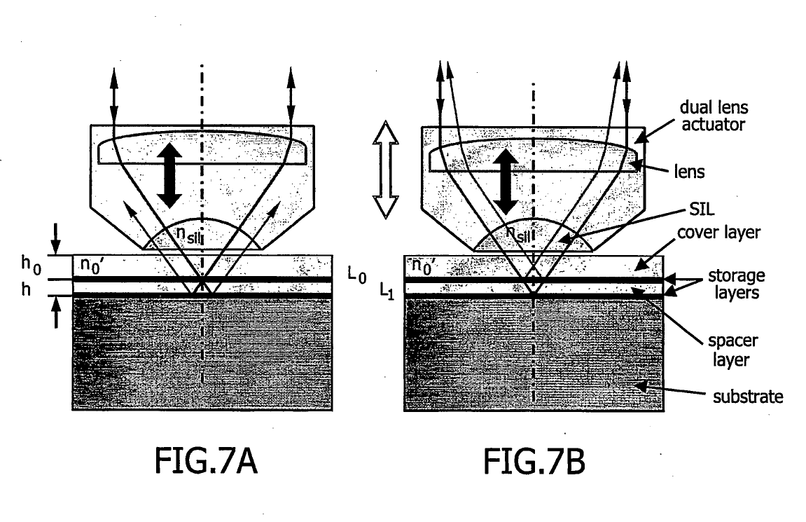

Now multi-layer optical data storage is discussed. At the same density of data per layer, multi-layer optical data storage systems with m layers (m>1) offer approximately m times more storage capacity than a single-layer system (m=1). Examples of such systems are the dual-layer (m=2) versions of the Digital Versatile Disc (DVD) and Blu Ray Disc (BD) systems. In these systems the data layers are separated by a so-called spacer layer which has a thickness h of approximately 45 microns in case of DVD and of 25 microns in case of BD. In FIG. 7, an example is given of a dual-layer near-field optical system. The data layer closest to the optical pickup unit, called L₀, is partly transparent.

The optimum distance of separation h between the data layers is determined by at least four criteria:

1. The focus S-curves of the data layers should be separated (guaranteed for large h):

$$h > [ \frac{λ}{n - \sqrt{{n}^{2} - {NA}^{2}}} ]$$

2. Coherent cross talk between layers (interference of their mutual reflections on the detector) causes a modulation of the RF signal with modulation depth 77. This effect should be sufficiently low to ensure that the “eye pattern” is sliced at a constant level (decreases with increasing h because the amount of light from the other layer—the one which is not being read—on the detector decreases with increasing h). If R_{m,eff} is the effective reflectivity of the m^{th} layer and all light is collected by the detector, the modulation depth is approximately given by (see Ref. [6]):

$$η = \frac{2}{π} \frac{λ}{h [ n - \sqrt{{n}^{2} - {NA}^{2}} ]} \sqrt{\frac{{R}_{1 , eff}}{{R}_{0 , eff}}}$$

3. Incoherent cross talk from channel code on out-of-focus layer should be sufficiently small. This is the extra noise resulting from the varying data pattern in the, out-of-focus, spot on the other layer. Incoherent noise is inversely proportional to the spot size and hence decreases with increasing h, because more data on the other layer is averaged due to the larger illuminated area for larger h.
4. Spherical aberration due to the different depth of the layers should be kept sufficiently small to ensure diffraction-limited quality of the laser focus on both layers. It increases with increasing h, and this puts an upper limit to h.

Clearly, the above criteria put the spacer layer thickness within bounds.

For further reading see for example Ref. [6]. Note that the idea of multi-layer near-field optical recording has been mentioned occasionally in the literature Ref. [7] (multi-layer) and Ref. [8] (dual layer).

Below it can be seen that a new scaling regime can be exploited for near-field optical data storage.

Furthermore, it may be concluded that:

The refractive index value of the spacer layers must be greater than the NA value.

Sputtered (inorganic) materials can have a very high refractive index, but sputtered spacer layers with thickness of the order of a micron or more are not possible on optical disks; mainly due to processing time and disk bending as a result of stress.

It is possible to spin-coat polymer spacer layers of the right thickness but polymers possess lower refractive index than some inorganic materials which limits the NA to about 1.6.

### On the Problem of Spherical Aberration:

Consider a converging beam of light which is made to be perfectly focussed in air. If a plane parallel plate is put in the beam, it will both displace the focus along the optical axis and introduce a certain amount of spherical aberration. Blu-ray Disc (BD) is a far-field (FF) optical recording standard using blue light with a wavelength of 405 nm and a numerical aperture NA=0.85. Spherical aberration for BD is 10 mλ/μm optical path difference (OPD) root mean square (RMS). For dual-layer Blu-ray Disc the spacer layer thickness is 25 μm, hence the total amount of spherical aberration acquired by going from one data storage layers to the other is 250 mλ. Compensation of any particular aberration is necessary in case it exceeds approximately ±20 mλ so that the total aberration of the recording system stays well below 71 mλ, the amount beyond which the optics can no longer be considered diffraction limited and the focus starts to get blurry.

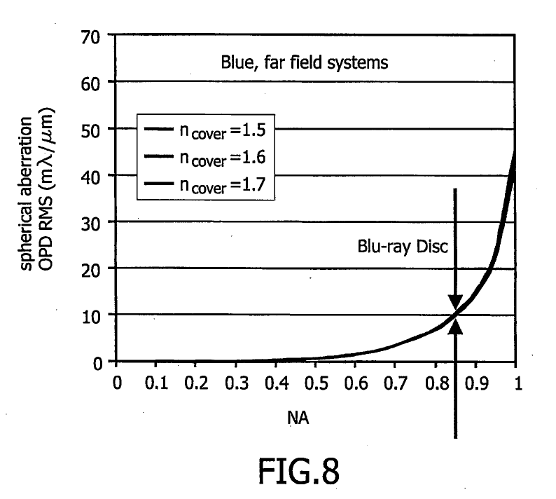

A known rule of thumb (from paraxial aberration theory) is that the amount of spherical aberration scales proportional with layer thickness and with the NA to the power of four. In the case of blue near-field (NF) optical recording, with NA=1.6, one might expect (1.6/0.85)⁴=12.6 times more spherical aberration than for Blu-ray Disc, which seems too large to correct for the same spacer layer thickness of 25 μm. In fact, scaling with NA is more complicated than suggested by the rule of thumb mentioned above (see for example Ref [14]). In FIG. 8, the proper scaling is given. It can be seen that for far-field systems the cover-layer refractive index is of little influence to the spherical aberration. The spherical aberration value for BD (NA=0.85) is indicated.

For multi-layer near-field recording, the three main problems to be solved relate to:

cross talk between data storage layers

optical absorption of the spacer and cover layers due to their high refractive index

spherical aberration due to different optical depths of each of the spacer layers

It is an object of the invention to provide an optical data storage system of the type mentioned in the opening paragraph, in which reliable data recording and read out is achieved using a near-field solid immersion lens. It is a further object to provide an optical data storage medium for use in such a system.

The first object has been achieved in accordance with the invention by an optical data storage system, which is characterized in that any one of hⱼ is larger than

$${h}_{j , min} = \frac{b λ \sqrt{{n}_{j}^{2} - {NA}^{2}}}{{NA}^{2}}$$

and NA<nⱼ and NA<n₀ and b>10, preferably b>15,
and the sum of all hⱼ is smaller than

$${h}_{max} = \frac{- λ ln f}{8 π nk} \sqrt{{n}^{2} - {NA}^{2}}$$

where n and k respectively are the mean real and imaginary parts of the refractive indexes of all spacer layers, weighed with the thickness of each spacer layer

$$n = \frac{{\sum }_{j}^{m - 1} {n}_{j} {h}_{j}}{{\sum }_{j}^{m - 1} {h}_{j}} and k = \frac{{\sum }_{j}^{m - 1} {k}_{j} {h}_{j}}{{\sum }_{j}^{m - 1} {h}_{j}}$$

where kⱼ is the imaginary part of the refractive index nⱼ of the spacer layer and f is the demanded double pass transmission of the marginal ray of the focused radiation beam.

The insight is that spacer layers are required that are both thin and flat to make multi-layer near-field recording feasible. Further, we have the insight that such layers can be made, how they can be made, what there precise properties are, and what materials could be used (see ref. [10]). Also there are insights into what consequences this has for the optical recording system.

Two regimes exist in which the effect of coherent cross talk in multi layer optical recording can be reduced substantially. The first regime is well known and applies to the DVD and BD optical recording standard: the optical data storage layers are well separated by a “thick” spacer layer. Over its full area, this spacer layer is not necessarily very flat compared to the wavelength of the laser used to scan the disk.

The new insight is that a second regime exists for which the effect of coherent cross talk is suppressed. It appears feasible to make spacer layers with a required flatness much better than a quarter wavelength if these layers are sufficiently “thin”. If the numerical aperture is large, the noise as a consequence of the incoherent cross talk from other data storage layers is still small enough to allow for thin spacer layers. Very large numerical apertures are the main reason for using near-field recording, hence flat and thin spacer layers open up a new regime for this technique in particular.

The further insight is that thin layers have additional advantages.

The first additional advantage is that thin layers have less optical attenuation due to light absorption, which allows for higher intrinsic absorption of the layer material. This is even more beneficial since this goes together with a higher refractive index of the layer material

The second additional advantage is that if thin spacer layers are used, the mutual distance between data storage layers is small, and hence the difference in optical path through the multi-layer storage medium when the light is focused on different layers is relatively small. A smaller optical path difference means that the amount of spherical aberration as a result of this path difference is also smaller. In particular it appears that under practical circumstances, e.g. a 4-layer near-field optical data storage system is feasible.

In an embodiment of the optical recording and reading system m=2 corresponding to a medium with one spacer layer.

In another embodiment the thickness variation Δh of any spacer layer over the whole medium fulfils the following criterium:

$$Δ h < \frac{λ}{4 {n}_{j}}$$

more preferably:

$$Δ h \leq \frac{λ}{8 {n}_{j} ( 1 + cos {θ}_{m} )} and cos {θ}_{m} = \sqrt{1 - {( NA / {n}_{j} )}^{2}} .$$

Preferably NA is larger than 1.5, which is the case for most near field optical recording systems.

In an alternative embodiment of the system hₘₐₓ is replaced by the following formula and the refractive index of the solid immersion lens n_{SIL} is n₆ and the refractive index of any of the spacer layers is nⱼ:

$${h}_{max} = \frac{{W}_{RMS}}{\sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {j}_{1} 〉}^{2}}}}$$

in which the variables have the following meaning:

$$〈 {f}_{s} 〉 = \frac{2}{3 {NA}^{2}} [ {n}_{s}^{3} - {( {n}_{s}^{2} - {NA}^{2} )}^{3 / 2} ] , \\ 〈 {f}_{j} 〉 = \frac{2}{3 {NA}^{2}} [ {n}_{j}^{3} - {( {n}_{j}^{2} - {NA}^{2} )}^{3 / 2} ] , \\ 〈 {f}_{s}^{2} 〉 = {n}_{s}^{2} - \frac{1}{2} {NA}^{2} , \\ 〈 {f}_{j}^{2} 〉 = {n}_{j}^{2} - \frac{1}{2} {NA}^{2} , \\ 〈 {f}_{s} {f}_{j} 〉 = \frac{1}{4 {NA}^{2}} \{ \begin{matrix}{n}_{s} {n}_{j}^{3} + {n}_{j} {n}_{s}^{3} - \\ ( {n}_{s}^{2} + {n}_{j}^{2} - 2 {NA}^{2} ) \sqrt{{n}_{s}^{2} - {NA}^{2}} \sqrt{{n}_{j}^{2} - {NA}^{2}} - \\ {( {n}_{s}^{2} + {n}_{j}^{2} )}^{2} log [ \frac{\sqrt{{n}_{s}^{2} - {NA}^{2}} - \sqrt{{n}_{j}^{2} - {NA}^{2}}}{{n}_{s} - {n}_{j}} ]\end{matrix} \}$$

and W_{RMS} is the maximum root mean square wavefront spherical aberration that can still be corrected for. See also “Compact description of substrate-related aberrations in high numerical-aperture optical disk readout”, Applied Optics, vol. 44, pp. 849-858 (2005).

The value of hₘₐₓ is limited by the maximum tolerable amount of spherical aberration according to the following constraint W_{RMS}<250 mλ, preferably <60 mλ, more preferably <15 mλ.

The further object has been achieved by an optical data storage medium for recording and reading using a focused radiation beam having a wavelength λ and a numerical aperture NA, comprising at least:

m data storage layers where m≧2, a cover layer that is transparent to the focused radiation beam, the cover layer having a thickness h₀ and a refractive index n₀, the data storage layers being separated by m-1 spacer layers having respective thicknesses hⱼ and refractive indices nⱼ, wherein j=1, . . . , m-1,

characterized in that,
any one of hⱼ is larger than

$${h}_{j , min} = \frac{b λ \sqrt{{n}_{j}^{2} - {NA}^{2}}}{{NA}^{2}}$$

and NA<nⱼ and NA<n₀ and b>10, preferably b>15,
and the sum of all hⱼ is smaller than

$${h}_{max} = \frac{- λ ln f}{8 π nk} \sqrt{{n}^{2} - {NA}^{2}}$$

where n and k respectively are the mean real and imaginary parts of the refractive indexes of all spacer layers, weighed with the thickness of each spacer layer:

$$n = \frac{{\sum }_{j}^{m - 1} {n}_{j} {h}_{j}}{{\sum }_{j}^{m - 1} {h}_{j}}$$

$$and$$

$$k = \frac{{\sum }_{j}^{m - 1} {k}_{j} {h}_{j}}{{\sum }_{j}^{m - 1} {h}_{j}}$$

where kⱼ is the imaginary part of the refractive index nⱼ of the spacer layer and f is the demanded double pass transmission of the marginal ray of the focused radiation beam. Preferably f>0.50, more preferably f>0.80 and more preferably f>0.90.

The requirement on spherical aberration then reads

$${\sum }_{j = 1}^{m - 1} {h}_{j} \frac{d W}{d h} {\vert}_{j} < {W}_{rms}$$

$$\frac{d W}{d h} {\vert}_{j} = \sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {j}_{1} 〉}^{2}}}$$

and the requirement on absorption reads

$${\sum }_{j = 1}^{m - 1} \frac{{n}_{j} {k}_{j}}{\sqrt{{n}_{j}^{2} - {NA}^{2}}} {h}_{j} < - \frac{- λ log f}{8 π}$$

where f is the required minimum intensity after double-pass through the stack of layers.
In an embodiment of the optical data storage medium m=2 corresponding to a medium with one spacer layer.

In another embodiment the thickness variation Δh of any spacer layer over the whole medium fulfils the following criterium:

$$Δ h < \frac{λ}{4 {n}_{j}}$$

more preferably:

$$Δ h \leq \frac{λ}{8 {n}_{j} ( 1 + cos {θ}_{m} )}$$

$$and$$

$$cos {θ}_{m} = \sqrt{1 - {( NA / {n}_{j} )}^{2}} .$$

Preferably nⱼ is larger than 1.5, more preferably 1.6, more preferably 1.7. This has the advantage that the full benefit of an high NA>1.5 can be utilized without the limitation of total internal reflection.

Alternatively in another embodiment hₘₐₓ is replaced by the following formula and the refractive index of the solid immersion lens n_{SIL} is n₆ and the refractive index of any of the spacer layers is nⱼ:

$${h}_{max} = \frac{{W}_{RMS}}{\sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {j}_{1} 〉}^{2}}}}$$

in which the variables, having the meaning of some aberration averages over the lens pupil, are given by

$$〈 {f}_{s} 〉 = \frac{2}{3 {NA}^{2}} [ {n}_{s}^{3} - {( {n}_{s}^{2} - {NA}^{2} )}^{3 / 2} ] , \\ 〈 {f}_{j} 〉 = \frac{2}{3 {NA}^{2}} [ {n}_{j}^{3} - {( {n}_{j}^{2} - {NA}^{2} )}^{3 / 2} ] , \\ 〈 {f}_{s}^{2} 〉 = {n}_{s}^{2} - \frac{1}{2} {NA}^{2} , \\ 〈 {f}_{j}^{2} 〉 = {n}_{j}^{2} - \frac{1}{2} {NA}^{2} , \\ 〈 {f}_{s} {f}_{j} 〉 = \frac{1}{4 {NA}^{2}} \{ \begin{matrix}{n}_{s} {n}_{j}^{3} + {n}_{j} {n}_{s}^{3} - \\ ( {n}_{s}^{2} + {n}_{j}^{2} - 2 {NA}^{2} ) \sqrt{{n}_{s}^{2} - {NA}^{2}} \sqrt{{n}_{j}^{2} - {NA}^{2}} - \\ {( {n}_{s}^{2} + {n}_{j}^{2} )}^{2} log [ \frac{\sqrt{{n}_{s}^{2} - {NA}^{2}} - \sqrt{{n}_{j}^{2} - {NA}^{2}}}{{n}_{s} - {n}_{j}} ]\end{matrix} \}$$

and W_{RMS} is the maximum root mean square wavefront spherical aberration that can still be corrected for.

The value of hₘₐₓ is limited by the maximum tolerable amount of spherical aberration according to the following constraint W_{RMS}<250 mλ, preferably <60 mλ, more preferably <15 mλ.

In an embodiment of the optical data storage medium the spacer layers comprise a polyimide substantially transparent to the radiation beam. Preferably the polyimide is UV curable.

The invention will now be explained in more detail with reference to the drawings in which

FIGS. 1A and 1B resp. show a normal far-field optical recording objective and data storage disk without cover layer and with cover layer,

FIGS. 2A and 2B resp. show a Near-Field optical recording objective and data storage disk without cover layer and with cover layer,

FIGS. 3A and 3B resp. show two principal examples of a near field lens design: lens with hemispherical SIL which has NA=n_{SIL} NA₀ snd lens with super hemispherical SIL which has NA=n_{SIL}² NA₀,

FIG. 4 shows a measurement of the total amount of the reflected light for the polarisation states parallel and perpendicular to the polarisation state of the irradiating beam, and the sum of both,

FIG. 5 shows that the thickness variation of the cover layer may be larger or smaller than the focal depth,

FIG. 6 shows an example of a spin-coated layer, a UV-curable silicone hard coat,

FIG. 7 shows that in a dual-layer optical data storage medium, the data layers, L₀ and L₁, are separated by a spacer layer of thickness h. The cover layer has thickness h₀. In FIG. 7A the laser is focussed on the top layer L₀, in FIG. 7B it is focused on the bottom layer L₁,

FIG. 8 shows the scaling of spherical aberration (Optical Path Difference) for blue, far-field optical storage versus numerical aperture,

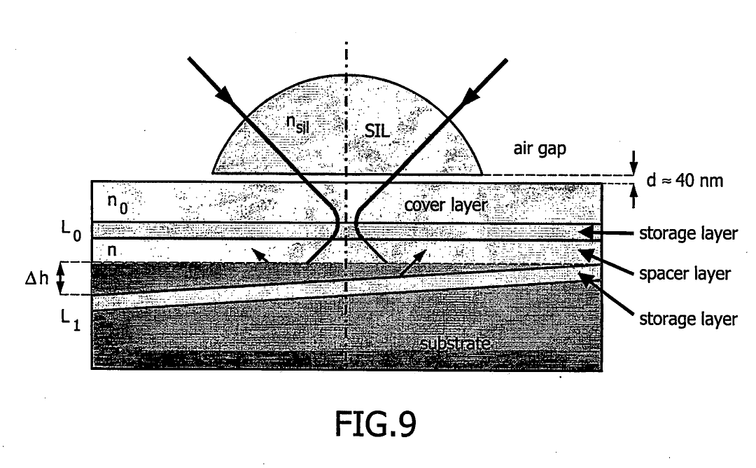

FIG. 9 shows that the thickness of the spacer layer may be larger or smaller than a quarter wavelength,

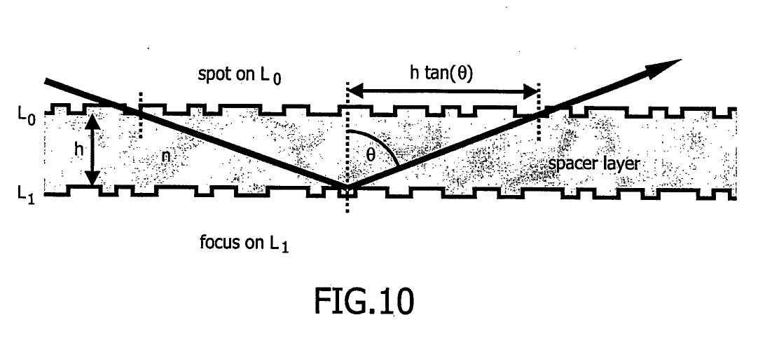

FIG. 10 shows that the spot on the out-of-focus layer contains many run lengths of data,

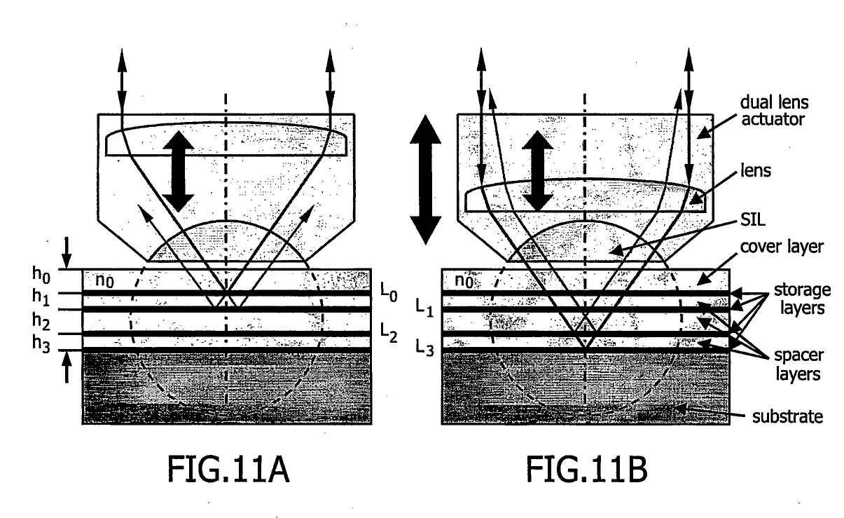

FIGS. 11A and 11B show that in a multi-layer optical data storage medium, the data layers are separated by a spacer layer of thickness h,

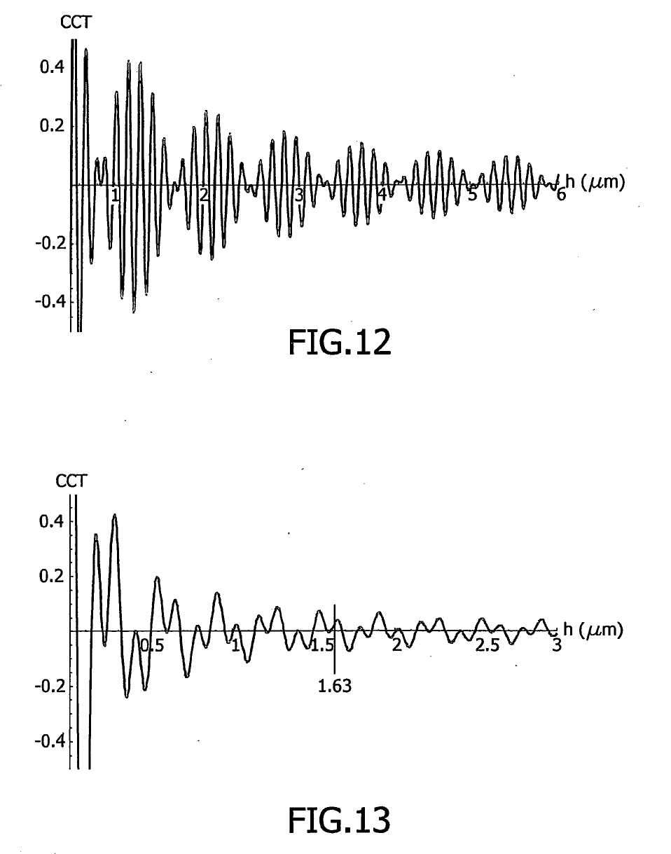

FIG. 12 shows the CCT-signal for spacer thickness h between 0.5 and 6 μm for the far-field case λ=0.405 μm, NA=0.85, and n=1.62,

FIG. 13 shows the CCT-signal for spacer thickness h between 0 and 3 μm for the near-field case λ=0.405 μm, NA=1.5, and n=1.62. The minimum thickness as scaled from DVD ICCT is hₘᵢₙ=1.63,

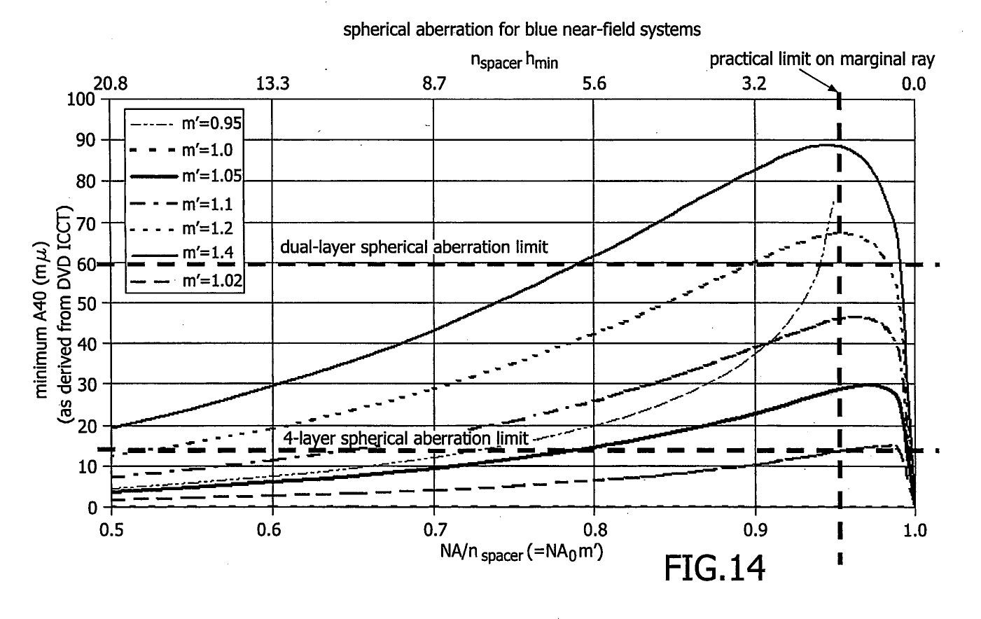

FIG. 14 shows the spherical aberration parameter space, scaled to the spacer refractive index n for the minimum spacer thickness hₘᵢₙ as scaled from DVD ICC between 0 and 20 μm for the near-field case λ=0.405 μm, NA between 0.5,

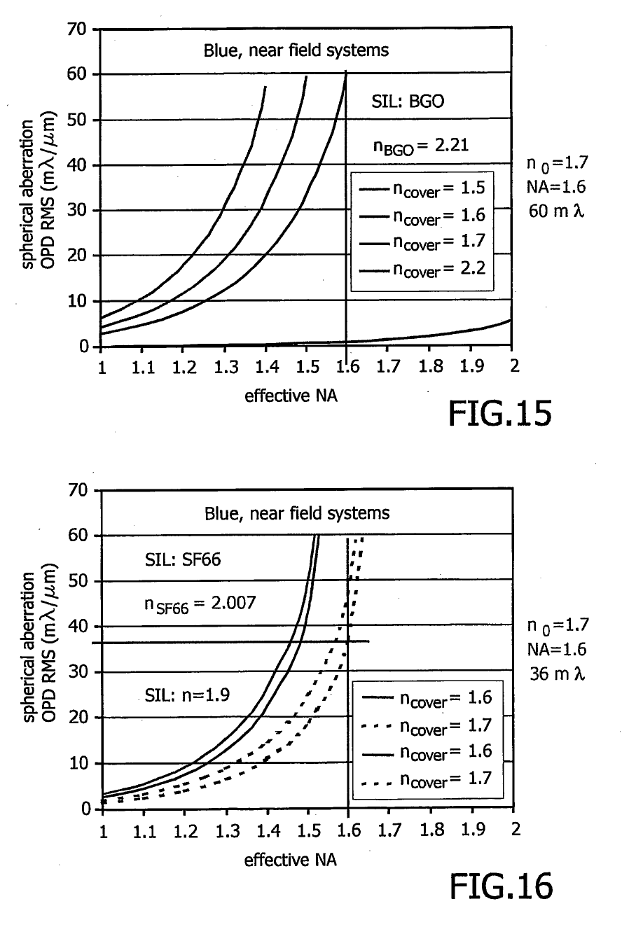

FIG. 15 shows the spherical aberration for near-field optics with a Bismuth Germanate (BGO) solid immersion lens (SIL). The spherical aberration is given for three values of the refractive index of the cover layer. The lowest value is obtained for the highest refractive index of the cover layer,

FIG. 16 shows the spherical aberration for near-field optics with a Bismuth Germanate (BGO) solid immersion lens (SWL) for different refractive indices of the SIL. The spherical aberration is lowest if SW and cover layer have the smallest difference in refractive index,

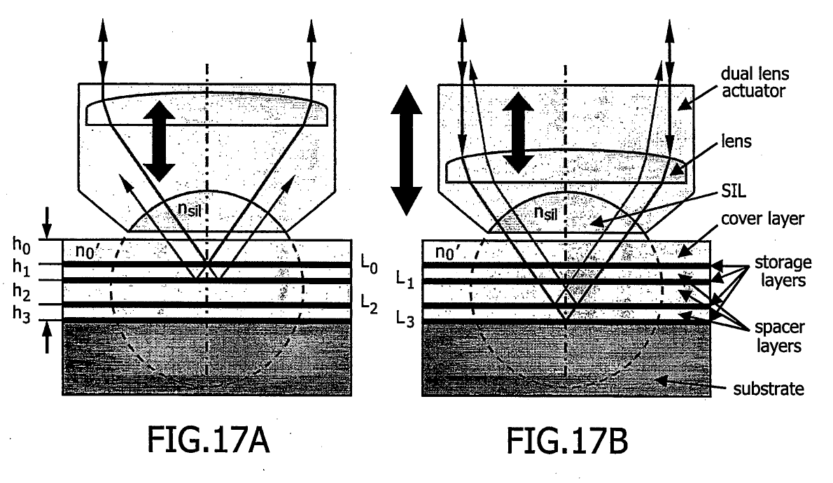

FIGS. 17A and 17B resp. show the principle of operation of a dual actuator in case of multi-layer optical storage when the first storage layer is in focus (FIG. 17A) and the air gap is kept constant by moving the objective as a whole and when the fourth storage layer is in focus (FIG. 17B),

FIG. 18 shows a dual layer lens design, comprising a first lens (top) and a SIL. The SIL is made conical to allow for a disk tilt of 2 mrad or 0.12°. The position of the first lens can be changed with respect to the SIL,

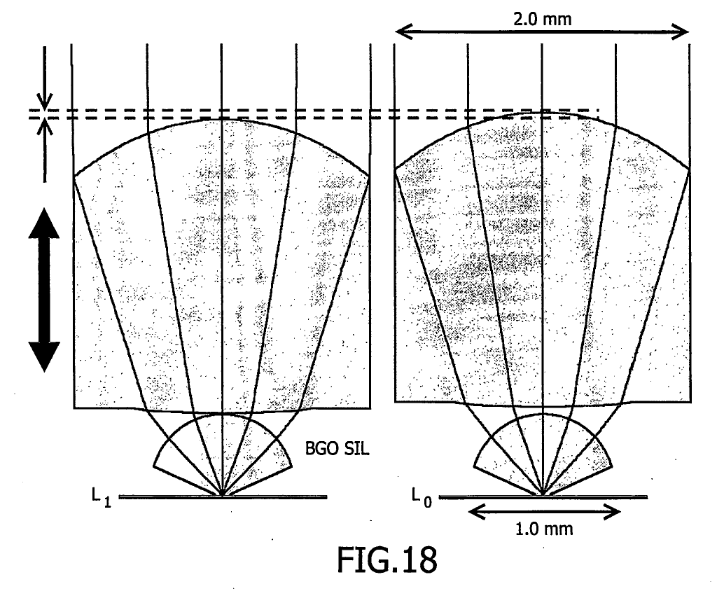

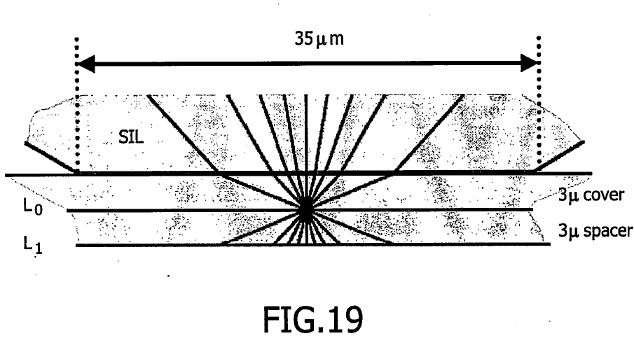

FIG. 19 shows a close-up on the optical disk of the focus on L₀ of the dual layer lens design of FIG. 18,

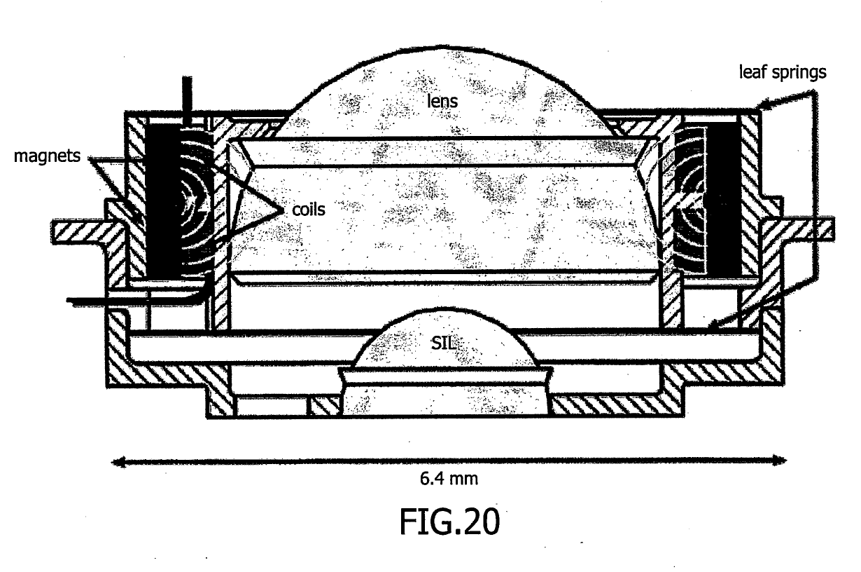

FIG. 20 shows a cross section of a possible embodiment of a dual lens actuator for near field. It is based on the HNA (high NA) design for DVR, see Ref. [11],

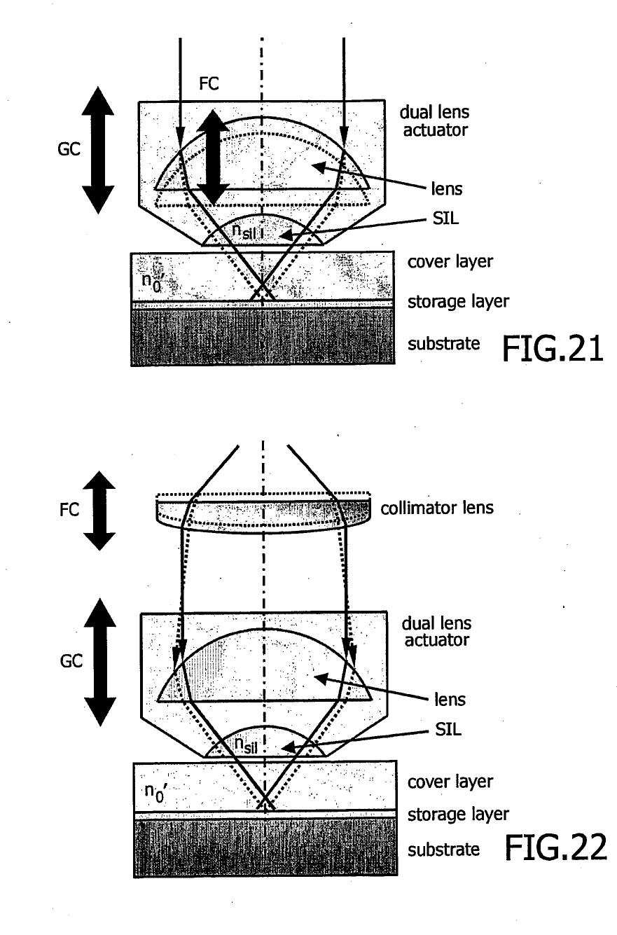

FIG. 21 shows that defocus can be obtained by moving the lens with respect to the SIL,

FIG. 22 shows that defocus also can be obtained by moving the laser collimator lens with respect to the objective,

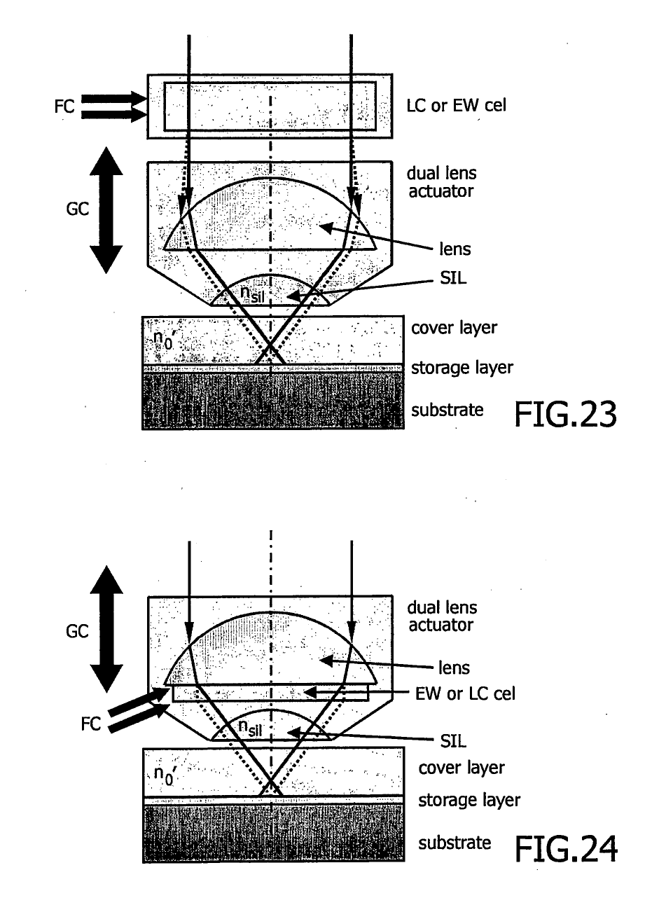

FIG. 23 shows a switchable optical element based on electrowetting (EW) or liquid crystal (LC) material can be used to adjust the focal length of the optical system. It is also possible to simultaneously compensate for a certain amount of spherical aberration in this way, and

FIG. 24 shows a switchable optical element based on electrowetting or liquid crystal material can be used to adjust the focal length of the optical system. Here it is placed between the first lens and the SIL. It is also possible to simultaneously compensate for a certain amount of spherical aberration in this way.

Multi-layer optical data storage can have a higher data capacity than the single layer technique.
More data layers implies that more spacer layers are required
the spacer layers should be a.o. spin-coatable, this implies a polymer
high numerical aperture NA requires high refractive index n
high n implies high absorption k
high k requires small data-layer spacing h
cross talk requires very flat spacer layers
small data-layer spacing allows for multi data-layer medium because spherical aberration and optical absorption both remain within limits

This closes the circle.

### Spacer Layer Thickness Scaling in Case of Near-Field Optical Data Storage

If the cover layer thickness is much smaller than the focal depth Δf≈nλ/(2NA²)) in and also the spacer layer thickness variation is much smaller than Δhⱼ=λ/(4nⱼ) (note that Δhⱼ≈Δf), then the Gap Error Signal can be used for controlling both the gap and focus, hence there is no need for a S-curves type focus error signal, and hence they do not have to be separated. If required, focus and spherical aberration offset signals can be derived from, for example, the RF modulation.

Indeed, if the spacer layer thickness variation is much smaller than Δhⱼ=λ/(4nⱼ), a quarter wavelength in the spacer layer medium, then there is no inter-layer interference modulation on RF signal, see FIG. 9. If thickness variation is small enough, Δh<<λ/(4n), a very useful parameter regime for optical recording is entered.

Regarding coherent cross talk, note that if the spacer layer thickness variation Δhⱼ is very small, it appears beneficial to choose the spacer layer thickness hⱼ such that an interference minimum occurs. For the simpler case of a small numerical aperture where all light propagates almost at right angles to the data storage layers, this would imply that the spacer layers have a thickness which is an odd integer multiple i of a quarter wavelength in the spacer layer material: hⱼ=iλ/(4nⱼ). For a refractive index n=1.70 and a wavelength λ_{vac}=405 nm this would imply thicknesses of ihⱼ≈60i nm, for example h=1.37 μm for i=23. In the case of a high numerical aperture, as is considered here, in combination with a spacer layer thickness which spans a substantial number of quarter wavelengths (i=23 in the example), a large number of concentric interference fringes exist. The integral intensity of the light on the detector from these fringes, which are alternating between constructive and destructive interference, tends to average out, which implies that the coherent cross talk modulation depth η will be greatly reduced for high numerical aperture. In fact, if R_{m,eff} is the effective reflectivity of the m^{th} layer and all light is collected by the detector, the modulation depth is approximately given by:

$$η = \frac{2}{π} \frac{λ}{h [ n - \sqrt{{n}^{2} - {NA}^{2}} ]} \sqrt{\frac{{R}_{1 , eff}}{{R}_{0 , eff}}}$$

For large numerical aperture, the exact thickness of the spacer layer will only have a small effect.

This leaves incoherent noise from channel code on out-of-focus layer as the most important scaling parameter. The noise as a result of incoherent cross talk can be estimated by determining the number of run lengths in the out-of-focus spot on the adjacent layer. In FIG. 10, the spot size on L₀ is estimated when the focus is on L₁.

The spot size A on L₀ is a function of the numerical aperture NAᵢₙₜ internal to the spacer layer, or the angle θ of the internal marginal ray.

Δ=π(h tan θ)²

If the channel bit length is T, then <T> is the average run length. The number of run lengths N_{<T}> illuminated in the out of focus spot is

$${N}_{< T >} = \frac{A}{< T {>}^{2}} = \frac{π {h}^{2} {NA}^{2}}{( {n}^{2} - {NA}^{2} ) < T {>}^{2}}$$

where we have neglected the track structure of the disk. Note that the track pitch is almost equal to the average run length (for DVD 740 mm, a factor of 1.156 and for BD 320 nm, a factor of 1.290). Note also that the area between the tracks has a constant reflectivity. The total incoherent noise depends on the ratio of the effective reflectivity of layers L₀ and L₁, the modulation depth of the data marks and the square root of 1/N_{<T}>. If N_{<T>,min} is the minimum number of run lengths to obtain sufficiently low incoherent crosstalk, then the minimum thickness of the spacer layer is given by

$${h}_{min} = \frac{< T >}{NA} \sqrt{{N}_{< T > , min} ( {n}^{2} - {NA}^{2} ) / π}$$

In Table I, the scaling of spacer layer thickness is given for some values of the refractive index of the spacer layer, the numerical aperture chosen and the run length scaled to BD value. The cases for DVD and BD where used to calculate an, apparently, suitable value for N_{<T>,min} using the value for h, the known spacer layer thickness. Calculated numbers are printed in bold, assumed values are printed normal. The bold numbers in the last column give the minimum required thickness of the spacer layer for five different sets of near-field system parameters. It is clear that typically hₘᵢₙ<2 μm. All examples given are for the blue wavelength of 405 nm except for the bottom row, which gives an example for ultra violet. This example shows that even in extreme cases the minimum spacer layer thickness doesn't get very much lower than a micron.

TABLE I
Spacer layer thickness scaling with incoherent noise

| | λ_{vac} | | | <T> | | | h |
|---|---|---|---|---|---|---|---|
| | (nm) | n | NA | (nm) | <T>/T | N_{<T>, min} | (μm) |
| DVD | 660 | | 0.60 | 640 | 4.8 | 2543 | 45 |
| BD | 405 | | 0.85 | 248 | 3.3 | 12603 | 25 |
| BNF1.45 | 405 | 1.60 | 1.45 | 145 | 3.3 | 2543 | 1.93 |
| BNF1.52 | 405 | 1.60 | 1.52 | 139 | 3.3 | 2543 | 1.30 |
| BNF1.60 | 405 | 1.70 | 1.60 | 132 | 3.3 | 2543 | 1.37 |
| BNF1.65 | 405 | 1.73 | 1.65 | 128 | 3.3 | 2543 | 1.15 |
| UVNF2.42 | 290 | 2.55 | 2.42 | 62 | 3.3 | 2543 | 0.59 |

### A DESIGN EXAMPLE

### Taking Absorption into Account

We would like to calculate the optical absorption of the marginal ray, which on the one hand has the longest optical path length D=2h/cos θ in the spacer material, and on the other hand is the most important because it determines the optical resolution. If f=I/I₀ is the relative intensity or transmission fraction, we have

$$f = \frac{I}{{I}_{0}} = {e}^{- D / {l}_{abs}}$$

with l_{abs}=λ_{vac}/(4πk) the absorption length of the material, we find

$$\begin{matrix}- ln f = \frac{D}{{l}_{abs}} \\ = \frac{8 π k h}{{λ}_{vac} cos θ}\end{matrix}$$

The imaginary part of the refractive index follows:

$$\begin{matrix}k = - ln f \frac{cos θ}{8 π h} \\ {λ}_{vac} = \frac{- ln f}{8 π n h} {λ}_{vac} \sqrt{{n}^{2} - {NA}^{2}}\end{matrix}$$

For designing the system, the internal numerical aperture NAᵢₙₜ is determined by choosing the angle θ of the internal marginal ray, see FIG. 10. Subsequently, the (external) NA is determined by the refractive index n of the layers. By choosing the minimum allowable total transmission fraction f of the marginal ray, an optimum (total) thickness hₒₚₜ of the spacer layer(s) can be calculated. This optimum is a trade-off between attenuation k and incoherent cross talk.

The following example is realistic:
1) Choose θ=70°, n=1.70, f=80% and a wavelength λ_{vac}=405 nm, then the following spacer-layer design rules are found:
2) Take the angle of the internal marginal ray θ=70°:

### NAᵢₙₜ=sin θ=0.94,

### NA=n sin θ=1.60,

3) Scaling of the average run length of Blue Ray Disk with the numerical aperture gives <T>=210.8/NA. This, together with N_{<T}>=2543, the average number of run lengths in the out-of-focus spot for DVD, yields the optimum thickness:

hₒₚₜ=6.0×10⁻⁶√(n²−NA²)/NA²=1.37 μm

4) The total transmission of the marginal ray f=80%, taken at optimum thickness is (double-pass at maximum NA):

k_{80%}=6.0×10⁻⁴NA²/n=9.0×10⁻⁴

Note that if, for example, f=90% that k_{90%}=0.47 k_{80%}.

Summarizing the outcome of this example, we find that the spacer layer has an optimum thickness of hₒₚₜ=1.37 μm. The spacer layer should be made of a material which actually can be deposited onto a disk with this thickness. Spin coating of a polymer offers the speed and accuracy of processing required as well as sufficiently high flatness (Δh<20 nm) and possibly low enough stress on the substrate (high stress would bend the disk making the surface hard to follow at the very small distance required for the optical objective). The material should have a refractive index n=1.70 and absorption of k=9.0×10⁻⁴. Polymer materials with specifications in this range of parameters exist, see Ref. [16]. If the actual absorption of the material chosen would be lower than this value, a material must exist that has a higher refractive index (possibly a modified version of the polymer chosen), which hence would support a higher numerical aperture, and which would have a higher absorption coefficient exactly matching the condition above.

In a multi-layer system based on the parameters given in the example above, for example with 4 layers and a cover layer, which would have a total thickness of 7 μm, the absorption is k=1.8×10⁻⁴. The maximum diameter of the spot on the cover layer is 39 μm when the bottom layer is in focus

### Example of a 4-Layer System

In FIGS. 11A and 11B a multi-layer optical data storage medium is depicted. In this example, the 4 layers L₀, L₁, L₂, and L₃, are separated by spacer layers of thickness h₁, h₂, and h₃, respectively. The cover layer has thickness h₀. In FIG. 11A, the laser, is focussed on the top layer, in FIG. 11B it is focussed on the bottom layer. Note that the separation distance between storage layers is taken unequal (h₁≠h₂≠h₃=h₁ in this case), which prevents indirect focussing on a storage layer whilst reading another layer, for example if one would take h₁=h₂=h₃ then, while reading L₃, the reflection from L₂ would cause a ghost focus on L₁ resulting in extra incoherent cross talk. This is because the data on the ghost layer is not average over a large spot.

Thus in FIGS. 11A and 11B an optical data storage system for recording and/or reading, using a radiation beam, i.e. a laser beam, having a wavelength λ=405 nm is shown. The laser beam is focused onto a data storage layer of an optical data storage medium. The system further comprises:

the medium having 4 (m=4) data storage layers and a cover layer that is transparent to the focused laser beam. Said cover layer has a thickness h₀=3.0 μm and a refractive index n₀=1.6. The data storage layers is separated by 3 (m-1) spacer layers having respective thicknesses h₁=2.0 μm, h₂=4.0 μm and h₃=2.0 μm and refractive indices nⱼ=1.60 and kⱼ=1.4×10⁻⁴ (corresponding to f=0.80) wherein j=1, 2 or 3,

an optical head, with an objective having a numerical aperture NA=1.44, said objective including a solid immersion lens (SIL) that is adapted for recording/reading at a free working distance of smaller than λ/10=40.5 nm from an outermost surface of said medium and arranged on the cover layer side of said optical data storage medium. From the solid immersion lens the focused laser beam is coupled by evanescent wave coupling into the optical storage medium during recording/reading.

Any one of hⱼ is larger than

$${h}_{j , min} = \frac{b λ \sqrt{{n}_{j}^{2} - {NA}^{2}}}{{NA}^{2}}$$

and NA<nⱼ=1.62 and NA<n₀ and b>10,
and the sum of all hⱼ is smaller than

$${h}_{max} = \frac{- λ ln f}{8 π n k} \sqrt{{n}^{2} - {NA}^{2}}$$

$$and$$

$$f = 0.80$$

where n and k respectively are the mean real and imaginary parts of the refractive indexes of all spacer layers, weighed with the thickness of each spacer layer:

$$n = \frac{{\sum }_{j}^{m - 1} {n}_{j} {h}_{j}}{{\sum }_{j}^{m - 1} {h}_{j}}$$

$$and$$

$$k = \frac{{\sum }_{j}^{m - 1} {k}_{j} {h}_{j}}{{\sum }_{j}^{m - 1} {h}_{j}}$$

where kⱼ is the imaginary part of the refractive index nⱼ of the spacer layer and f is the demanded double pass transmission of the marginal ray of the focused radiation beam. Another possible set of parameters at an NA of 1.52 is h₀=3.0 and h₁=1.3 μm, h₂=2.6 μm and h₃=1.3 μm and refractive indices nⱼ=1.60 and kⱼ=1.3×10⁻⁴ (corresponding to f=0.80) wherein j=1, 2 or 3.

The thickness variation Δh of any spacer layer over the whole medium fulfils the following criterium:

$$Δ h \leq \frac{λ}{8 n ( 1 + cos {θ}_{m} )}$$

$$and$$

$$cos {θ}_{m} = \sqrt{1 - {( NA / n )}^{2}} .$$

Multi-layer near-field optical data storage is possible because thin cover and spacer layers can be used. A possible hierarchy of reasoning is given below:

because the cover and spacer layers are thin, they can be made very flat.

because the spacer layers are very flat, the storage layers can be put close together without negative effects from coherent cross talk (i.e. the spacer layers may be thin).

because the spacer layers are thin, layer to layer spherical aberration is small.

because the layers are thin, they are allowed to have a higher optical absorption coefficient k for a given maximum attenuation, which in turn allows for a higher refractive index n (as a result of the (fundamental) Kramers-Kronig law which connects the real and imaginary parts of the refractive index by a causality reasoning).

because the refractive index is higher, the layer thickness can be even smaller!

because the refractive index is higher, the NA is higher and hence the data capacity is quadratically higher.

### Dual-Layer Near Field (NF) Recording: (In)Coherent Cross-Talk Optical Absorption and Spherical Aberration Limits to Spacer Thickness

Consider a dual layer system with wavelength λ, numerical aperture NA, spacer thickness h, and spacer refractive index n. The reflection of the two layers is assumed to be equal in amplitude and phase. The interference fringes in the pupil average out apart from the fringe at the center of the pupil and the fringe at the rim of the pupil. The average of the fringes over the collecting aperture of the objective lens results in a term in the central aperture signal, normalized by the signal amplitude, give rise to coherent cross talk (CCT):

$$C C T = 2 sin c [ \frac{2 π n h ( 1 - cos {θ}_{m} )}{λ} ] cos [ \frac{2 π n h ( 1 + cos {θ}_{m} )}{λ} ]$$

$$cos {θ}_{m} = \sqrt{1 - {( NA / n )}^{2}}$$

where θₘ is the polar angle of the marginal ray in the spacer layer, and where sinc(x)=sin(x)/x. The periodicity of the cos-term is λ/n(1+cos θₘ), which is approximately λ/2n if NA is sufficiently small, and is due to the path length difference 2h. The periodicity appearing in the sinc term is related to the phase difference between the central and outer fringe and has a periodicity λ/n(1−cos θₘ), which is related to the focal depth inside the spacer layer, i.e. the axial intensity profile is:

$$I ( z ) = {I}_{max} sin {c}^{2} [ \frac{π n z ( 1 - cos {θ}_{m} )}{λ} ]$$

which has it's first zero at z=λ/n(1−cos θₘ). For sufficiently small NA we find that the focal depth λ/n(1−cos θₘ) is approximately 2nλ/NA². A plot of the CCT-signal for the far-field case λ=0.405 μm, NA=0.85, n=1.62 is shown in FIG. 12. In this case the cos-factor oscillates much faster than the sinc-factor. The dependence of the CCT-signal on spacer thickness is therefore minimized at the zero-points of the sinc-function. These are found if the path length difference 2h is an integer number i times the focal depth λ/n(1−cos θₘ). For the near-field case the periodicity of the cos-factor is comparable to the periodicity of the sinc-factor, giving for λ=0.405 μm, NA=1.5, n=1.62 a plot like FIG. 13. Clearly, the previous recipe (2h=i λ/n(1−cos θₘ)) is not so useful anymore. A different recipe is not so straightforward. For example, the dependence on spacer thickness h is minimum if h is chosen such that the CCT-signal is minimum or maximum. Requirements for flatness are, for example, that the variation ah must be sufficiently small compared to the smallest of the two periodicities, λ/n(1+cos θₘ), say:

$$Δ h \leq \frac{λ}{8 n ( 1 + cos ( {θ}_{m} )} [ << \frac{λ}{4 n} ]$$

which evaluate h to Δh≦23 nm.

The minimum spacer layer thickness as scaled from dual-layer DVD, which takes into account the noise due to random data in the out-of-focus layer (incoherent cross talk, ICCT), is:

$${h}_{j , min} = \frac{b λ \sqrt{{n}_{j}^{2} - {NA}^{2}}}{{NA}^{2}}$$

and NA<nⱼ and NA<n₀ and b>10, preferably b>15,

A first practical maximum spacer layer thickness is a.o. demanded by the absorption of the spacer material (another reason is the absolute thickness uniformity, which is better for thinner layers). For a total transmission of the marginal ray of, say f=80% (double pass at θₘ), we find:

$${h}_{max} = \frac{- λ ln f}{8 π n k} \sqrt{{n}^{2} - {NA}^{2}}$$

where n and k respectively are the mean real and imaginary parts of the refractive indexes of all spacer layers, weighed with the thickness of each spacer layer:

$$n = \frac{{\sum }_{j}^{m - 1} {n}_{j} {h}_{j}}{{\sum }_{j}^{m - 1} {h}_{j}}$$

$$and$$

$$k = \frac{{\sum }_{j}^{m - 1} {k}_{j} {h}_{j}}{{\sum }_{j}^{m - 1} {h}_{j}}$$

where kⱼ is the imaginary part of the refractive index nⱼ of the spacer layer and f is the demanded double pass transmission of the marginal ray of the focused radiation beam. k is related to the extinction coefficient by

$$α = \frac{8 π k ln 10}{λ}$$

It is important to note that materials with high refractive index n also have high k. From the above it follows that k≦6×10⁻⁴ NA²/n=8.3×10⁻⁴. This rules out most organic materials (i.e. spin-coatable polymers) in case we demand that n>1.7.

Another practical maximum spacer layer thickness is demanded by the amount of spherical aberration induced by the spacer layer when the laser focus is moved from one data layer to the next data layer. From a practical point of view, using additional variable optical elements in the light path, it is possible to correct for only a limited amount of spherical aberration, of the order of about 250 milliwaves RMS (root mean; square).

The residual spherical aberration on each layer should be less than approximately ±30 milliwaves RMS to guarantee sufficiently low total aberration of the total light path.

For a lens and beam of numerical aperture NA focused from a medium with refractive index n₁ (the SIL) into a layer of refractive index n₂ and, the RMS wavefront spherical aberration per thickness h is given by.

$$\frac{{W}_{RMS}}{h} = \sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {f}_{s} 〉}^{2}}}$$

in which the variables (having the meaning of some aberration averages over the lens pupil) are given by

$$〈 {f}_{s} 〉 = \frac{2}{3 {NA}^{2}} [ {n}_{s}^{3} - {( {n}_{s}^{2} - {NA}^{2} )}^{3 / 2} ]$$

$$\begin{matrix}〈 {f}_{j} 〉 = \frac{2}{3 {NA}^{2}} [ {n}_{j}^{3} - {( {n}_{j}^{2} - {NA}^{2} )}^{3 / 2} ] \\ 〈 {f}_{s}^{2} 〉 = {n}_{s}^{2} - \frac{1}{2} {NA}^{2} \\ 〈 {f}_{j}^{2} 〉 = {n}_{j}^{2} - \frac{1}{2} {NA}^{2} \\ 〈 {f}_{s} {f}_{j} 〉 = \frac{1}{4 {NA}^{2}} \{ \begin{matrix}{n}_{s} {n}_{j}^{3} + {n}_{j} {n}_{s}^{3} - ( {n}_{s}^{2} + {n}_{j}^{2} - 2 {NA}^{2} ) \\ \sqrt{{n}_{s}^{2} - {NA}^{2}} \sqrt{{n}_{j}^{2} - {NA}^{2}} - \\ {( {n}_{s}^{2} - {n}_{j}^{2} )}^{2} log [ \frac{\sqrt{{n}_{s}^{2} - {NA}^{2}} - \sqrt{{n}_{j}^{2} - {NA}^{2}}}{{n}_{s} - {n}_{j}} ]\end{matrix} \}\end{matrix}$$

These equations can be scaled with respect to the refractive index of the spacer layer, for example by introducing the parameters m′=nₛ/nⱼ and s′=NA/nⱼ. In FIG. 14 the spherical aberration for some values of m′ is given for a thickness hₘᵢₙ as found from DVD incoherent cross talk. The top horizontal axis gives n_{spacer}hₘᵢₙ=nⱼhₘᵢₙ as found from DVD incoherent cross talk, which is a simple function of s′=NA/nⱼ, the bottom horizontal axis. A value of 60 mλ RMS spherical aberration is just tolerable for a dual layer system. Equivalently, a value of 15 mλ RMS spherical aberration is just tolerable for a 4-layer system. In both cases a maximum of ±30 mλ RMS spherical aberration per layer is obtained. As can be seen from FIG. 14 a small ratio mj of is preferred: m′<1.2 or preferably m′<1.02.

Table II gives the RMS spherical aberration for some values of the NA and both the spacer layer n₂ and SIL refractive index nₛ. A typical spacer layer may have a thickness of 1.4 micron and a refractive index nⱼ=1.7. If the SIL refractive index nₛ=1.9, the table shows that the spherical aberration is A₄₀=W_{RMS}/λ=36.95×1.4/2=±26 milliwaves. Note that this means that no extra spherical aberration compensating means are required in the example given.

TABLE II
spherical aberration (mλ/μm) RMS (A₄₀) at λ = 405 nm

| n₂ | 1.60 | | | 1.70 | | | 1.73 | | |
|---|---|---|---|---|---|---|---|---|---|
| (spacer) | | | | | | | | | |
| NA | 1.45 | 1.50 | 1.55 | 1.55 | 1.60 | 1.65 | 1.55 | 1.60 | 1.65 |
| n₁ (SIL) | | | | | | | | | |
| 2.210 | 42.83 | 58.68 | 84.76 | 43.49 | 59.31 | 85.36 | 36.59 | 48.90 | 67.80 |
| 2.086 | 38.98 | 53.85 | 78.67 | 38.13 | 52.59 | 76.85 | 31.41 | 42.42 | 59.62 |
| 1.900 | 30.63 | 43.18 | 64.89 | 26.03 | 36.95 | 56.34 | 19.72 | 27.35 | 39.92 |

### Spherical Aberration in Case of Near-Field Optical Data Storage

It will be shown that the amount of spherical aberration for a multi-layer near-field optical system due to cover layer and spacer layers can be kept within acceptable bounds (see also Ref. [14]). A total aberration of 71 mλ OPD RMS is considered to be diffraction limited. The spherical aberration should be distinctly less than this number. In the BD system the total spherical aberration is 250 mλ OPD RMS, and active compensation by, for example a liquid crystal cell, is required. It seems reasonable to assume that it is possible to compensate for an amount of 250 mλ OPD RMS spherical aberration in near-field systems, and we will use it as a bench mark.

In FIG. 15, spherical aberration at blue wavelength (405 nm) is shown for near-field optics with a Bismuth Germanate (BGO) solid immersion lens (SIL). The spherical aberration is given for three values of the refractive index of the cover layer. It shows that the lowest value is obtained for the highest refractive index of the cover layer. For a refractive index n=1.7, and numerical aperture NA=1.6, we find 60 mλ/μm OPD RMS spherical aberration. This limits the multi-layer stack thickness (cover plus spacer layers) to approximately 250/60≈4.2 μm.

In FIG. 16, spherical aberration at blue wavelength (405 nm) is shown for near-field optics with solid immersion lenses made of SF66 with refractive index n=2.007 and a glass with refractive index n=1.9. The spherical aberration is given for two values of the refractive index of the cover layer. For a cover layer refractive index of n=1.7 this limits the multi-layer stack thickness to approximately 250/36≈7.0 μm. This would be sufficient to make a 4-layer disk with 1.37 μm spacer layers and a 1.5 μm cover layer.

The results from both FIG. 15 and FIG. 16 shown that the lowest value is obtained for the highest refractive index of the cover layer.

Note that scaling of spherical aberration for near field (NF) disk is not directly intuitive if the far field (FF) values are known, see FIG. 8, where we found for Blu-ray Disk (the same wavelength) a value of 10 mλ/μm OPD RMS, which for a spacer layer of 25 μm multiplies to 25 μm×10 mλ/μm=250 mλ for a Dual layer Blu-ray Disk. The data in FIG. 15 and FIG. 16, which we calculated using the theoretical results of Ref. [14], show much lower values for the spherical aberration than extrapolation of the data in FIG. 8 would have suggested (the aberration seems to diverge beyond NA=1). This can be traced back to the apparent fact that it is the angle θ rather than the numerical aperture NA=n sin θ which determines the aberration (see also the remark made about the numerical aperture in relation to FIG. 3).

The data shown in FIG. 15 and FIG. 16 also suggest that the refractive index difference between SIL and cover must be made small to obtain low spherical aberration, and that values lower than 30 mλ/μm OPD RMS should be possible. This is more clearly seen in FIG. 14, where for m=1 we find A₄₀=0. The spacer thickness typically will be less than 2 μm, which multiplies to 2 μm×30 mλ/μm=60 mλ for a dual-layer near-field disk.

In case the refractive index of the polymer cover layer and spacer layer is chosen to be n=1.7, the SIL should preferably have a refractive index of i=1.7 as well. In order to obtain a high numerical aperture of the objective, a higher value of the refractive index of the SIL may be desirable, however.

### EXAMPLE

### Near-Field System with Dual Layer NA=1.6 Over Single Layer NA=2.0

### ISSUES for Dual Layer NA≈1.6:

Critical thickness variation for cover and spacer layer

Light path and objective lens complexity (focus jump, spherical aberration)

The availability of high refractive index (n>1.7) spin-coatable polymers

The first of the above issues has been addressed earlier in this invention disclosure, the other two will be discussed below. None of these issues seems to be a fundamental problem.

### Benefits for Dual Layer NA≈1.6:

Compare to single layer NA=2.0 system, a dual-layer system with NA=1.6 can have 28% more capacity.

Polymer spacer for NA≈1.6 compared to sputtered spacer for NA≈2.0:

layers with several μm thickness are no problem with polymers

thick polymer spacers cause very little stress (less disk bending)

spin-coating much faster than sputtering

Polymer cover for NA≈1.6 compared to sputtered cover for NA≈2.0:

polymers have lower thermal conductivity, this implies a lower surface temperature on phase change disk

layers with several μm thickness are no problem with polymers

thick polymer covers cause very little stress (less disk bending)

spin-coating much faster than sputtering

reduced sensitivity to small scratches

Pit and groove dimensions for NA 1.6 compared to NA≈2.0:

easier and faster mastering

easier replication

larger de-tracking margin, 1.25× smaller DC gain for servo

larger phase change effects compared to phase change crystallites

more efficient diffraction for TE (and TM) polarized spot

Benefits of NA≈1.6 objective lens compared to NA≈2.0 lens:

larger air gap (40 nm versus 25 nm) allowed for same NF coupling efficiency

larger residual air gap error

wider lens making margins

larger spot for NA≈1.6: more read power than NA≈2.0 (better SNR)+

1.25× smaller MTF cut-off frequency: less integrated media noise better SNR

### Static Focus Control

Given that the total thickness h of cover layer and a number m of spacer layers does have sufficiently small thickness variation, Δh=Δh₁+Δh₂+ . . . +Δhₘ, say its combined thickness varies by less than 20-50 nm, we propose a static correction of focal length to compensate for combined cover layer plus spacer layer thickness variations, in addition to the dynamic air gap correction.

The purpose is that the data (storage) layer is in focus and at the same time the air gap between SIL and cover layer is kept constant so that proper evanescent coupling is guaranteed.

The position of the optical objective should be adjusted according to some gap error signal to maintain the gap width constant to within less than 5 nm.

A combined cover layer and spacer layer with thickness variation of substantially less than both the focal depth and a quarter wavelength in the spacer layer eliminates the need of dynamic focus control of the objective which is otherwise required in addition to the gap servo, see European patent application simultaneously filed by present applicant with reference number PHNL040460. Only a static focus control and spherical aberration correction to accommodate disk-to-disk variance is desired. This can be realised by optimising the modulation depth of a known signal, for example from a lead-in track.

For example, an objective lens comprising two elements which can be axially displaced to adjust the focal length of the pair without substantially changing the air gap. The air gap can then be adjusted by moving the objective as a whole, see FIGS. 17A and 17B. The air gap is kept constant (the SIL controlled so as to follow the disk surface) but by the lens is displaced to gain focus on the fourth storage layer. In general, a certain amount of spherical aberration will remain. In some cases, optimum design of the lens system, cover layer and spacer layer combination will meet the system requirements, in other cases active adjustment of spherical aberration will be required and further measures will have to be taken.

Note that European patent application simultaneously filed by present applicant with reference numbers PHNL040460 and PHNL040461, not only apply to a single-layer optical system, but to a multi-layer optical system as well.

High Refractive Index of Polymers: an Example of n>1.7

High refractive index polymers exist with refractive index as high as n=1.9, see for example the materials made by Brewer Science Inc. The most interesting compounds for our application seems to come from the so-called polyimides. Optical absorption of light at a wavelength of 405 nm is high, but for some materials it is low enough to be applicable within the thickness regime as indicated by this invention disclosure.

The material should have a refractive index n=1.70 and absorption of k=9.0×10⁻⁴. Polymer materials with specifications in this range of parameters exist, see Ref. [16].

To convert between absorption quantities k (the imaginary part of the refractive index) and α (the extinction coefficient) the following equation can be used:

$$α = \frac{4 π k ln 10}{λ} \approx 0.289 \frac{k}{λ} ( {cm}^{- 1} )$$

for λ in meters.

### Dual Layer NF Objective Lens: Optical Design Example NA=1.5

This design, used here as an example of feasibility, was made by applicant, see FIG. 19 and FIG. 20.

### Parameters Assumed for the Design:

Glass molded lens for 405 nm wavelength

NA=1.5

cover layer thickness 3 μm (n=1.62)

spacer layer thickness 3 μm (n=1.62)

focus jump from data layer L₀ to L₁ with constant air gap

The focus jump requires:

change of collimator position,

change distance between first lens and SIL.

Focus on L₀: NA=1.50, OPD=0 mλ RMS, Conjugate dist.=Infinity
Focus on L₁: NA=1.53° OPD=14 mλ RMS, Conjugate dist.=−78 mm.
Tolerances for 15 mλ OPD RMS: Field: Δφ=0.22°, SIL off-axis: Δr=7 μm, SIL thickness:

At =12 μm, Asphere off-axis: Δr=1.0 μm.

The thickness tolerance of the BGO SIL is quite large, the asphere off-axis margin is tight but feasible. This example shows that a dual-layer near-field lens is feasible.

### Typical Examples of Lenses, Correctors and Light Paths (See Also PHNL040460)

A dual lens actuator has been designed, see FIG. 20 and Ref. [11], which has a Lorentz motor to adjust the distance between the two lenses within the recorder objective. The lens assembly as a whole fits within the actuator. The dual lens actuator consists of two coils that are wound in opposite directions, and two radially magnetised magnets. The coils are wound around the objective lens holder and this holder is suspended in two leaf springs. A current through the coils in combination with the stray field of the two magnets will result in a vertical force that will move the first objective lens towards or away from the SIL. A near field design may look like the drawing in FIG. 21.

Alternative embodiments to the one shown in FIGS. 11, 17, 18, 20 and 21 to change the focal position of the system comprise, for example, adjustment of the laser collimator lens, see FIG. 22, or a switchable optical element based on electrowetting or liquid crystal material, see FIGS. 23 and 24 and also Ref. [7]. These measures, of course, can be taken simultaneously.

### REFERENCES

[1] Ferry Zijp and Yourii V. Martynov, “Static tester for characterization of optical near-field coupling phenomena”, in Optical Storage and Information Processing, Proceedings of SPIE 4081, pp. 21-27 (2000).
[2] Kimihiro Saito, Tsutomu Ishimoto, Takao Kondo, Ariyoshi Nakaoki, Shin Masuhara, Motohiro Furuki and Masanobu Yamamoto, “Readout Method for Read Only Memory Signal and Air Gap Control Signal in a Near Field Optical Disc System”, Jpn. J. Appl. Phys. 41, pp. 1898-1902 (2002).
[3] Martin van der Mark and Gavin Phillips, “(Squeaky clean) Hydrophobic disk and objective”, (2002); see international patent application publication WO 2004/008444-A2 (PHNL0200666).
[4] Bob van Someren; Ferry Zijp; Hans van Kesteren and Martin van der Mark, “Hard-coat protective thin cover layer stack media and system”, see international patent application publication 2004/008441-A2 (2002) (PHNL0200667).
[5] TeraStor Corporation, San Jose, Calif., USA, “Head including a heating element for reducing signal distortion in data storage systems”, U.S. Pat. No. 6,069,853 (Jan. 8, 1999).
[6] Wim Koppers, Pierre Woerlee, Hubert Martens, Ronald van den Oetelaar and Jan Bakx, “Finding the optimal focus-offset for writing dual layer DVD+R/+RW: Optimised on pre-recorded data”, (2002); see international patent application WO 2004/086382-A1.
[7] Tom D. Milster, Y. Zhang, S-K Park and J-S. Kim, “Advanced lens design for bit-wise volumetric optical data storage”, technical digest p. 270-271, ISOM 2003.
[8] Imation Corporation, Oakdale, Minn. (ISA), “Rewritable Optical Data Storage Disk Having Enhanced Flatness”, U.S. Pat. No. 6,238,763.
[9] F. Zijp, R. J. M. Vullers, H. W. van Kesteren, M. B. van der Mark, C. A. van den Heuvel, B. van Someren, and C. A. Verschuren, “A Zero-Field MAMMOS recording system with a blue laser, NA=0.95 lens, fast magnetic coil and thin cover layer”, OSA Topical Meeting: Optical Data Storage, Vancouver, 11-14 May 2003.
[10] Piet Vromans, ODTC, Philips, see international patent application publication WO 2004/064055-A1.
[11] Y. V. Martynov, B. H. W. Hendriks, F. Zijp, J. Aarts, J.-P. Baartman, G. van Rosmalen J. J. H. B. Schleipen and H. van Houten, “High numerical aperture optical recording: Active tilt correction or thin cover layer?”, Jpn. J. Appl. Phys. Vol. 38 (1999) pp. 1786-1792.
[12] deleted.
[13] B. J. Feenstra, S. Kuiper, S. Stalling a, B. H. W. Hendriks, R. M. Snoeren, “Variable focus lens”, see international patent application publication WO 2003/069380-A1. S. Stalling a, “Optical scanning device with a selective optical diaphragm”, U.S. Pat. No. 6,707,779 B1.
[14] Several optical wavefront aberration compensators:
S. Stalling a, “Optical scanning device”, see international patent application publication WO 2004/029949-A2.
B. H. W. Hendriks, J. E. de Vries, S. Stalling a, “Optical scanning device”, see international patent application publication WO 2003/049095-A2,A3.
B. H. W. Hendriks, S. Stalling a, H. van Houten, “Optical scanning device”, U.S. Pat. No. 6,567,365 B1.
J. J. Vrehen, J. Wals, S. Stalling a, “Optical scanning head”, U.S. Pat. No. 6,586,717 B2.
[15] K. Osato, S. Kai, Y. Takemoto, T. Nakao, K. Nakagawa, A. Kouchiyama, K. Aratani, “Phase Transition Mastering for Blu ray ROM disc”, OSA Topical Meeting: MDI, Optical Data Storage, Vancouver, 11-14 May 2003.
[16] Tony Flaim, Yubao Wang, and Ramil Mercado (Brewer Science Inc.), “High Refractive Index Polymer Coatings for Optoelectronics Applications”, SPIE Proceedings of Optical Systems Design 2003.

1. An optical data storage system for recording and/or reading, using a radiation beam having a wavelength λ, focused onto a data storage layer of an optical data storage medium, said system comprising:
the medium having m data storage layers where m≧2 and a cover layer that is transparent to the focused radiation beam, said cover layer having a thickness h₀ and a refractive index n₀, the data storage layers being separated by m-1 spacer layers having respective thicknesses hⱼ and refractive indices nⱼ, wherein j=1, . . . , m-1,
an optical head, with an objective having a numerical aperture NA, said objective including a solid immersion lens that is adapted for recording/reading at a free working distance of smaller than λ/10 from an outermost surface of said medium and arranged on the cover layer side of said optical data storage medium, and from which solid immersion lens the focused radiation beam is coupled by evanescent wave coupling into the optical storage medium during recording/reading,
characterized in that,
any one of hⱼ is larger than
$${h}_{j , min} = \frac{b λ \sqrt{{n}_{j}^{2} - {NA}^{2}}}{{NA}^{2}}$$
and NA<nⱼ and NA<n₀ and b>10, preferably b>15,
and the sum of all hⱼ is smaller than
$${h}_{max} = \frac{- λ ln f}{8 π n k} \sqrt{{n}^{2} - {NA}^{2}}$$
where n and k respectively are the mean real and imaginary parts of the refractive indexes of all spacer layers, weighed with the thickness of each spacer layer:
$$n = \frac{{\sum }_{j}^{m - 1} {n}_{j} {h}_{j}}{{\sum }_{j}^{m - 1} {h}_{j}}$$
$$and$$
$$k = \frac{{\sum }_{j}^{m - 1} {k}_{j} {h}_{j}}{{\sum }_{j}^{m - 1} {h}_{j}}$$
where kⱼ is the imaginary part of the refractive index nⱼ of the spacer layer and f is the demanded double pass transmission of the marginal ray of the focused radiation beam.

2. An optical data storage system as claimed in claim 1, wherein m=2 corresponding to a medium with one spacer layer.

3. An optical data storage system as claimed in claim 1, wherein the thickness variation Δh of any spacer layer over the whole medium fulfils the following criterium:
$$Δ h < \frac{λ}{4 n}$$

4. An optical data storage system as claimed in claim 3, wherein the thickness variation Δh of any spacer layer over the whole medium fulfils the following criterium:
$$Δ h \leq \frac{λ}{8 n ( 1 + cos {θ}_{m} )}$$
$$and$$
$$cos {θ}_{m} = \sqrt{1 - {( NA / n )}^{2}} .$$

5. An optical data storage system as claimed in claim 1 wherein NA is larger than 1.5.

6. An optical data storage system as claimed in claim 1, wherein hₘₐₓ is replaced by the following formula and the refractive index of the solid immersion lens n_{SIL} is nₛ and the refractive index of any of the spacer layers is nⱼ:
$${h}_{max} = \frac{{W}_{RMS}}{\sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {f}_{s} 〉}^{2}}}}$$
in which the variables have the following meaning:
$$\begin{matrix}〈 {f}_{s} 〉 = \frac{2}{3 {NA}^{2}} [ {n}_{s}^{3} - {( {n}_{s}^{2} - {NA}^{2} )}^{3 / 2} ] , \\ 〈 {f}_{j} 〉 = \frac{2}{3 {NA}^{2}} [ {n}_{j}^{3} - {( {n}_{j}^{2} - {NA}^{2} )}^{3 / 2} ] , \\ 〈 {f}_{s}^{2} 〉 = {n}_{s}^{2} - \frac{1}{2} {NA}^{2} , \\ 〈 {f}_{j}^{2} 〉 = {n}_{j}^{2} - \frac{1}{2} {NA}^{2} , \\ 〈 {f}_{s} {f}_{j} 〉 = \frac{1}{4 {NA}^{2}} \{ \begin{matrix}\begin{matrix}{n}_{s} {n}_{j}^{3} + {n}_{j} {n}_{s}^{3} - ( {n}_{s}^{2} + {n}_{j}^{2} - 2 {NA}^{2} ) \\ \sqrt{{n}_{s}^{2} - {NA}^{2}} \sqrt{{n}_{j}^{2} - {NA}^{2}} -\end{matrix} \\ {( {n}_{s}^{2} - {n}_{j}^{2} )}^{2} log [ \frac{\sqrt{{n}_{s}^{2} - {NA}^{2}} - \sqrt{{n}_{j}^{2} - {NA}^{2}}}{{n}_{s} - {n}_{j}} ]\end{matrix} \}\end{matrix}$$
and W_{RMS} is the maximum root mean square wavefront spherical aberration.

7. An optical data storage system as claimed in claim 6, wherein W_{RMS}<250 mλ, preferably <60 mλ, more preferably <15 mλ.

8. An optical data storage medium for recording and reading using a focused radiation beam having a wavelength λ and a numerical aperture NA, comprising at least:
m data storage layers where m≧2, a cover layer that is transparent to the focused radiation beam, the cover layer having a thickness h₀ and a refractive index n₀, the data storage layers being separated by m-1 spacer layers having respective thicknesses hⱼ and refractive indices nⱼ, wherein j=1, . . . , m-1,
characterized in that,
any one of h₁, . . . , hₘ₋₁ is larger than
$${h}_{j , min} = \frac{b λ \sqrt{{n}_{j}^{2} - {NA}^{2}}}{{NA}^{2}}$$
and NA<nⱼ and NA<n₀ and b>10, preferably b>15,
and the sum of all hⱼ is smaller than
$${h}_{max} = \frac{- λ ln f}{8 π n k} \sqrt{{n}^{2} - {NA}^{2}}$$
where n and k respectively are the mean real and imaginary parts of the refractive indexes of all spacer layers, weighed with the thickness of each spacer layer
$$n = \frac{{\sum }_{j}^{m - 1} {n}_{j} {h}_{j}}{{\sum }_{j}^{m - 1} {h}_{j}}$$
$$and$$
$$k = \frac{{\sum }_{j}^{m - 1} {k}_{j} {h}_{j}}{{\sum }_{j}^{m - 1} {h}_{j}}$$
where kⱼ is the imaginary part of the refractive index nⱼ of the spacer layer and f is the demanded double pass transmission of the marginal ray of the focused radiation beam.

9. An optical data storage medium as claimed in claim 8, wherein m=2 corresponding to a medium with one spacer layer.

10. An optical data storage medium as claimed in claim 8, wherein the thickness variation Δh of any spacer layer over the whole medium fulfils the following criterium:
$$Δ h < \frac{λ}{4 n}$$

11. An optical data storage medium as claimed in claim 10, wherein the thickness variation Δh of any spacer layer over the whole medium fulfils the following criterium:
$$Δ h \leq \frac{λ}{8 n ( 1 + cos {θ}_{m} )}$$
$$and$$
$$cos {θ}_{m} = \sqrt{1 - {( NA / n )}^{2}} .$$

12. An optical data storage medium as claimed in claim 8 wherein n is larger than 1.5.

13. An optical data storage medium as claimed in claim 8, wherein hₘₐₓ is replaced by the following formula and the refractive index of the solid immersion lens n_{SIL} is nₛ and the refractive index of any of the spacer layers is nⱼ:
$${h}_{max} = \frac{{W}_{RMS}}{\sqrt{〈 {f}_{j}^{2} 〉 - {〈 {f}_{j} 〉}^{2} - \frac{{[ 〈 {f}_{s} {f}_{j} 〉 - 〈 {f}_{s} 〉 〈 {f}_{j} 〉 ]}^{2}}{〈 {f}_{s}^{2} 〉 - {〈 {f}_{s} 〉}^{2}}}}$$
in which the variables have the following meaning:
$$\begin{matrix}〈 {f}_{s} 〉 = \frac{2}{3 {NA}^{2}} [ {n}_{s}^{3} - {( {n}_{s}^{2} - {NA}^{2} )}^{3 / 2} ] , \\ 〈 {f}_{j} 〉 = \frac{2}{3 {NA}^{2}} [ {n}_{j}^{3} - {( {n}_{j}^{2} - {NA}^{2} )}^{3 / 2} ] , \\ 〈 {f}_{s}^{2} 〉 = {n}_{s}^{2} - \frac{1}{2} {NA}^{2} , \\ 〈 {f}_{j}^{2} 〉 = {n}_{j}^{2} - \frac{1}{2} {NA}^{2} , \\ 〈 {f}_{s} {f}_{j} 〉 = \frac{1}{4 {NA}^{2}} \{ \begin{matrix}\begin{matrix}{n}_{s} {n}_{j}^{3} + {n}_{j} {n}_{s}^{3} - ( {n}_{s}^{2} + {n}_{j}^{2} - 2 {NA}^{2} ) \\ \sqrt{{n}_{s}^{2} - {NA}^{2}} \sqrt{{n}_{j}^{2} - {NA}^{2}} -\end{matrix} \\ {( {n}_{s}^{2} - {n}_{j}^{2} )}^{2} log [ \frac{\sqrt{{n}_{s}^{2} - {NA}^{2}} - \sqrt{{n}_{j}^{2} - {NA}^{2}}}{{n}_{s} - {n}_{j}} ]\end{matrix} \}\end{matrix}$$
and W_{RMS} is the maximum root mean square wavefront spherical aberration.

14. An optical data storage medium as claimed in claim 13, wherein W_{RMS}<250 mλ, preferably <60 mλ, more preferably <15 mλ.

15. An optical data storage medium as claimed in claim 8, wherein the spacer layers comprise a polyimide substantially transparent to the radiation beam.

16. An optical data storage medium as claimed in claim 15, wherein the polyimide is UV curable.
